(19) United States
(12) Patent Application Publication
(10) Pub. No.: US 2015/0358768 A1
(43) Pub. Date: Dec. 10, 2015

(54) INTELLIGENT DEVICE CONNECTION FOR WIRELESS MEDIA IN AN AD HOC ACOUSTIC NETWORK

(71) Applicants: Michael Edward Smith Luna, San Jose, CA (US); Thomas Alan Donaldson, Nailsworth (GB); Derek Boyd Barrentine, Gilroy, CA (US)

(72) Inventors: Michael Edward Smith Luna, San Jose, CA (US); Thomas Alan Donaldson, Nailsworth (GB); Derek Boyd Barrentine, Gilroy, CA (US)

(73) Assignee: AliphCom, San Francisco, CA (US)

(21) Appl. No.: 14/301,227

(22) Filed: Jun. 10, 2014

(51) Int. Cl. H04W 4/02; G01S 5/02

(52) U.S. Cl. CPC H04W 4/02; G01S 5/0268; H04W 84/18

(57) ABSTRACT

Techniques associated with intelligent device connection for wireless media in an ad hoc acoustic network are described, including receiving a radio signal from an outside media device, determining whether the radio signal includes identifying information, evaluating the radio signal to calculate location data associated with a location of the outside media device, determining whether the location of the outside media device is within a threshold proximity of a primary media device, sending request to the outside media device, the request comprising an instruction to the outside media device to provide an acoustic output, receiving response data from the outside media device, capturing an acoustic signal using an acoustic sensor, determining the acoustic signal to be associated with the acoustic output from the outside media device, and generating acoustic network data using the acoustic signal, the acoustic network data identifying the outside media device as being part of the acoustic network.

### CROSS-REFERENCE TO RELATED APPLICATIONS

This application is related to co-pending U.S. patent application Ser. No. XX/XXX,XXX (Attorney Docket No. ALI-211), filed Jun. 10, 2014, and entitled “Intelligent Device Connection for Wireless Media In An Ad Hoc Acoustic Network,” which is incorporated by reference herein in its entirety for all purposes.

### FIELD

The present invention relates generally to electrical and electronic hardware, electromechanical and computing devices. More specifically, techniques related to intelligent device connection for wireless media in an ad hoc acoustic network are described.

### BACKGROUND

Mobility has become a necessity for consumers, and yet conventional solutions for device connection between mobile and wireless devices typically are not well-suited for seamless use and enjoyment of content across wireless devices. Although protocols and standards have been developed to enable devices to recognize each other with little or no manual configuration, a substantial amount of manual setup and manipulation is still required to hand off the output of media and other content, including internet, telephone and videophone calls. Not only do conventional techniques require a user to manually switch from one device to another, such as switching from watching a movie on a mobile computing device to watching it on a larger screen television upon entering a room with such a television, or to turn off a headset or mobile phone when entering an environment from which the other end of the phone call is originating. Further, a user is usually required to perform significant actions to manually manipulate devices to accomplish the desired switching. This is in part because conventional devices typically are not equipped to determine whether other networked devices are located properly or optimally within a network to provide content.

Conventional solutions for playing media also are typically not well-suited for automatic, intelligent setup and configuration across a user's devices. Typically, when a user uses a device, a manual process of setting up a user's account and preferences, or linking a new device to a previously set up user account, is required. Although there are conventional approaches for saving a user's account in the cloud, and downloading content and preferences associated with the account across multiple devices, such conventional approaches typically require a user to download particular software onto a computer (i.e., laptop or desktop), and to synchronize such data manually.

Thus, what is needed is a solution for an intelligent device connection for wireless media in a network without the limitations of conventional techniques.

### BRIEF DESCRIPTION OF THE DRAWINGS

Various embodiments or examples (“examples”) are disclosed in the following detailed description and the accompanying drawings:

FIG. 1 illustrates an exemplary wireless media ecosystem, including wireless media devices within an acoustic network;

FIG. 2 illustrates a diagram depicting an exemplary architecture for an intelligent device connection unit implemented in a media device;

FIG. 3 depicts a functional block diagram depicting interactions between components of wireless media devices implementing intelligent device connection units;

FIGS. 4A-4B depicts ad hoc expansion of an acoustic network;

FIG. 5 illustrates an exemplary flow for ad hoc expansion of an acoustic network;

FIG. 6 depicts an exemplary flow of signals in a headset implementing an intelligent device connection unit;

FIG. 7 illustrates an exemplary flow for ad hoc switching of a headset implementing an intelligent device connection unit; and

FIG. 8 illustrates an exemplary computing platform disposed in a media device implementing an intelligent device connection unit.

The above-described drawings depict various examples of the various embodiments of the invention, which are not limited by the depicted examples. It is to be understood that, in the drawings, like reference numerals designate like structural elements. Also, it is understood that the drawings are not necessarily to scale.

### DETAILED DESCRIPTION

Various embodiments or examples may be implemented in numerous ways, including as a system, a process, an apparatus, a device, and a method associated with a wireless media ecosystem. In some embodiments, devices in a wireless media ecosystem may be configured to automatically create or update (i.e., add, remove, or update information associated with) an ad hoc acoustic network with minimal or no manual setup. An acoustic network includes two or more devices within acoustic range of each other. As used herein, “acoustic” may refer to any type of sound wave, or pressure wave that propagates at any frequency, whether in an ultrasonic frequency range, human hearing frequency range, infrasonic frequency range, or the like.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

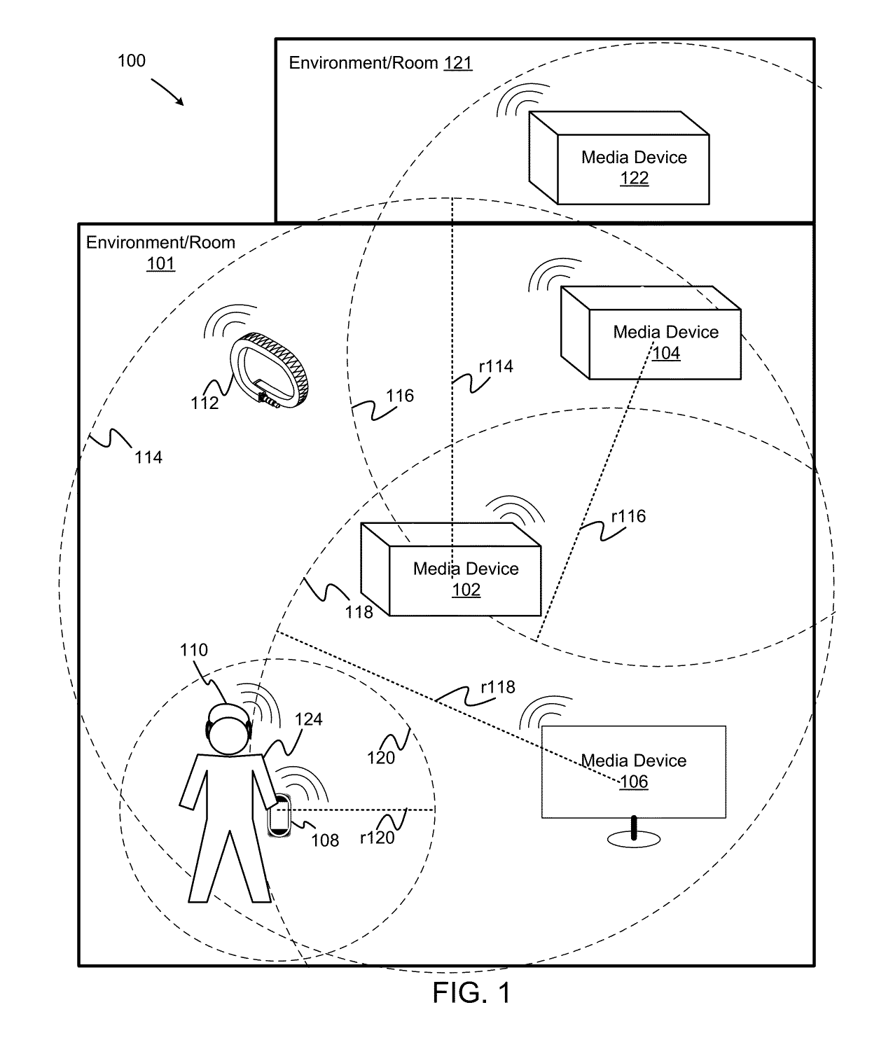

FIG. 1 illustrates an exemplary wireless media ecosystem, including wireless media devices within an acoustic network. Here, ecosystem 100 includes media devices 102-106 and media device 122, mobile device 108, headphones 110, and wearable device 112, each located in one of environment/rooms 101 or 121. As used herein, “media device” may refer to any device configured to provide or play media (e.g., art, books, articles, abstracts, movies, music, podcasts, telephone calls, videophone calls, internet calls, online videos, other audio, other video, other text, other graphic, other image, and the like), including, but not limited to, a loudspeaker, a speaker system, a radio, a television, a monitor, a screen, a tablet, a laptop, an electronic reader, an integrated smart audio system, an integrated audio/visual system, a projector, a computer, a smartphone, a telephone, a cellular phone, other mobile devices, and the like. In particular, media device 122 may be located in environment/room 121, and other media devices may be located in environment/room 101. In some examples, environment/rooms 101 and 121 may comprise an enclosed, or substantially enclosed, room bounded by one or more walls, and one or more doors that may be closed, which may block, obstruct, deflect, or otherwise hinder the transmission of sound waves, for example, between environment/room 101 and environment/room 121. In other examples, environment/rooms 101 and 121 may be partially enclosed with different types of obstructions (e.g., furniture, columns, other architectural structures, interfering acoustic sound waves, other interfering waves, or the like) hindering the transmission of sound waves between environment/room 101 and environment/room 121. In some examples, media devices 102-106 and media device 122, mobile device 108, headphones 110, and wearable device 112, each may be configured to communicate wirelessly with each other, and with other devices, for example, by sending and receiving radio frequency signals using a short-range communication protocol (e.g., Bluetooth®, NFC, ultra wideband, or the like) or a long-range communication protocol (e.g., satellite, mobile broadband, GPS, WiFi, and the like).

In some examples, media devices 102-106 may be configured to play audio media content, including stored audio files, radio content, streaming audio content, audio content associated with a phone or internet call, audio content being played, or otherwise provided, using another wireless media player, and the like. In some examples, media devices 102-106 may be configured to play video media content, including stored video files, television content, streaming video content, video content associated with a videophone or internet call, video content being played, or otherwise provided, using another wireless media player, and the like. Examples of media devices 102-106 are described and disclosed in co-pending U.S. patent application Ser. No. 13/894,850 filed on May 15, 2013, with Attorney Docket No. ALI-195, which is incorporated by reference herein in its entirety for all purposes.

In some examples, each of the devices in environment/rooms 101 and 121 may be associated with a threshold proximity (e.g., threshold proximities 114-120) indicating a maximum distance away from a primary device (i.e., the device with which said threshold proximity applies and is associated, and by which said threshold proximity is stored) within which a theoretical acoustic network may be set up given ideal or near ideal conditions (i.e., where no physical or other tangible barriers or obstructions are present to hinder the transmission of an acoustic sound wave, and a strong acoustic signal source (i.e., loud or otherwise sufficient in magnitude)). In some examples, such a threshold may be associated with a maximum distance or radius in which a primary device is configured to project an acoustic signal, beyond which an acoustic signal from said primary device becomes too weak to be captured by an acoustic sensor (e.g., microphone, acoustic vibration sensor, ultrasonic sensor, infrasonic sensor, and the like), for example, less than 15 dB, less than 20 dB, or otherwise unable to be captured by an acoustic sensor when interfered with by ambient noise. For example, media device 102 may be associated with threshold proximity 114, as defined by radius r114, and thus any device capable of acoustic output within radius r114 of media device 102 (e.g., media devices 104-106, mobile device 108, and the like) may be a candidate for being included in an acoustic network with media device 102. In another example, media device 104 may be associated with threshold proximity 116 having radius r116, and any device capable of acoustic output within radius r116 of media device 104 (e.g., media devices 102 and 122) may be a candidate for being included in an acoustic network with media device 104. In still other examples, media device 106 may be associated with threshold proximity 118 having a radius r118, and mobile device 108 may be associated with threshold proximity 120 having a radius r120. Once two or more of the devices in environment/rooms 101 and 121 have identified each other as being within an associated threshold proximity, acoustic signals may be exchanged between said two or more devices (i.e., output by a device and captured, or not captured, by another device) in order to determine whether said devices are appropriately within an acoustic network (i.e., an actual acoustic network, wherein member devices in an acoustic network have determined that they are within “hearing,” or acoustic sensing, distance of one another at either audible or inaudible frequencies).

In some examples, media device 104 may be configured to sense radio signals generated and output by some or all of the devices in environment/rooms 101 and 121, and to determine that media device 102 and media device 122 are within threshold proximity 116. In some examples, media device 104 may be configured to send queries to media devices 102 and 122 requesting identifying information, requesting an acoustic output, and receiving response data from media devices 102 and 122 providing information and metadata associated with a provision of said acoustic output, as described herein. Identifying information may include a type of, address for, name for, service offered by or available on, communication capabilities of, acoustic output capabilities of, other identification of, and other data characterizing, a source device (i.e., a source of said identifying information). In some examples, media device 104 may implement an acoustic sensor configured to capture an acoustic signal associated with said acoustic output from media devices 102 and 122. In some examples, media device 104 may be configured to determine, based on acoustic sensor data associated with a captured acoustic signal, and response data from media devices 102 and 122, whether media devices 102 and 122 should be included in an acoustic network with media device 104. For example, media device 104 may capture an acoustic signal from media device 102, evaluating a received signal strength (i.e., a magnitude, or other indication of a power level, of a signal being received by a sensor or receiver at a distance away from a signal source) associated with said acoustic signal, for example, using response data indicating a time that media device 102 played, or provided, an acoustic output resulting in said acoustic signal, and determining that media device 102 is suitable for inclusion in an acoustic network with media device 104. In some examples, said response data also may provide metadata associated with said acoustic output by media device 102, including a length of the acoustic output, a type of the acoustic output (e.g., ultrasonic, infrasonic, human hearing range, frequency range, note, tone, music sample, and the like), a time or time period during which the acoustic output is being provided, or the like. Without any significant obstructions or hindrances between media device 102 and media device 104, an acoustic signal received by one from the other, and vice versa, may be strong (i.e., have a high received signal strength) and closely correlated (e.g., in time (i.e., short or no delay), quality, strength relative to original output signal, and the like) with acoustic output characterized by response data. In some examples, media device 104 may receive response data from media device 122, and capture a very weak, significantly delayed, or no acoustic signal associated with an acoustic output from media device 122. In some examples, media device 104 may determine, using said response data and the weak, significantly delayed, or lack of, acoustic signal (e.g., due to a wall between environment/room 101 and environment/room 121, or other obstruction or interference hindering the transmission of acoustic signals between environment/room 101 and environment/room 121) received by media device 104 from media device 122, that media device 122 is not suitable for inclusion in an acoustic network with media device 104. In other examples, the quantity, type, function, structure, and configuration of the elements shown may be varied and are not limited to the examples provided.

In some examples, a time delay between transmission of an acoustic signal from media device 102 and receipt of said acoustic signal from media device 104, or vice versa, in reference to response data, also may help determine a distance between media devices 102 and 104, and thus also a level of collaboration that may be achieved using media devices 102 and 104. For example, if media devices 102 and 104 are close enough to provide coordinated acoustic signals (i.e., same or similar acoustic signal at the same or a predetermined time or time interval) to a target or end location (i.e., a user) less than approximately 50 milliseconds apart, then they may be used in collaboration to provide audio output to a user at said location. If, on the other hand, media devices 102 and 104 are far enough apart that even when providing coordinated acoustic signals, said coordinated acoustic signal from media device 102 is received more than, for example, approximately 50 milliseconds apart from said coordinated acoustic signal from media device 104, then media devices 102 and 104 will be perceived by a user to be disparate audio sources. In other examples, acoustic output from media devices 102-106 may be coordinated with built-in delays based on distances and locations relative to each other to provide coordinated or collaborative acoustic output to a user at a given location such that the user perceives said acoustic output from media devices 102-106 to be in synchronization. In still other examples, the quantity, type, function, structure, and configuration of the elements shown may be varied and are not limited to the examples provided.

In another example, media device 102 may sense radio signals from media devices 104-106, mobile device 108, headphones 110 and wearable device 112. In some examples, media device 102 may be configured to determine, using said radio signals, identifying information, acoustic output requests/queries, response data and captured acoustic signals, one or more of the following: that media devices 104-106 are within threshold proximity 114 and within an acoustic sensing range of media device 102 (i.e., thus able to sense (i.e., capture using an acoustic sensor) acoustic output from media device 102) and vice versa (i.e., media device 102 is within acoustic sensing range of media devices 104 and 106), and thus are suitable for including in an acoustic network with media device 102; that mobile device 108 is unsuitable to be included in said acoustic network because media device 102 is not within threshold proximity 120, and thus may not be able to sense acoustic output from mobile device 108; that headphones 110 also are unsuitable to be included in said acoustic network because headphones 110 have an even more focused acoustic output (i.e., directed into a user's ears), which may be unable to reach media device 102; that wearable device 112 is unable to provide an acoustic output; that media device 122 is outside of threshold proximity 114, and thus outside of an acoustic sensing range of media device 102; among other characteristics of ecosystem 100. In still other examples, a threshold proximity may be defined using a metric other than a radius. In some examples, location data associated with each of media devices 102-106 (i.e., relative direction and distances between media devices 102-106, directional and distance data relative to one or more walls of environment/room 101, and the like) may be generated or updated based on acoustic data from exchanged acoustic signals, which may provide a richer data set from which to derive more precise location data. For example, each of media devices 102-106 may be configured to evaluate a strength or magnitude of an acoustic signal received from another of media devices 102-106, mobile device 108, headphones 110, and the like, to determine a distance between two of said devices, as described herein. In some examples, once media devices 102-106 have established each other to be suitable to be included in an acoustic network, media devices 102-106 may be configured to exchange configuration data and/or other setup data (e.g., network settings, network address assignments, hostnames, identification of available services, location of available services, and the like) to establish said acoustic network. In some examples, once an acoustic network is established, automatic selection of a device in said acoustic network for playing, streaming, or otherwise providing, media content, for example for consumption by user 124, may be performed by one or more of media device 102-106 and/or mobile device 108. For example, mobile device 108 may be causing headphones 110 to play music, or other media content, (e.g., stored on mobile device 108, streamed from a radio station, streamed from a third party service using a mobile application, or the like), until user 124 brings mobile device 108 or headphones 110 into a threshold environment/room 101 and/or within one or more of threshold proximities 114-118, causing one or more of media devices 102-106 to query mobile device 108 for identifying information. In some examples, media devices 102-106 also may be configured to query mobile device 108 whether there is any media content being played (i.e., consumed by user 124), and to determine whether, and/or which of, media devices 102-106 may be more suitable, or optimally suited, to provide said media content to user 124. In other examples, mobile device 108 may be configured to provide media devices 102-106 with media content data associated with media content being consumed by user 124, and to request an automatic determination of whether, and/or which of, media devices 102-106 may be more suitable, or optimally suited, to provide said media content to user 124. In some examples, media devices 102-106, mobile device 108 and headphones 110, may be configured to hand-off the function of providing media content to each other, techniques for which are described in co-pending U.S. patent application Ser. No. 13/831,698, filed Mar. 15, 2013, with Attorney Docket No. ALI-191CIP1, which is herein incorporated by reference in its entirety for all purposes. In other examples, the quantity, type, function, structure, and configuration of the elements shown may be varied and are not limited to the examples provided.

In some examples, mobile device 108 may be implemented as a smartphone, other mobile communication device, other mobile computing device, tablet computer, or the like, without limitation. In some examples, mobile device 108 may include, without limitation, a touchscreen, a display, one or more buttons, or other user interface capabilities. In some examples, mobile device 108 also may be implemented with various audio and visual/video output capabilities (e.g., speakers, video display, graphic display, and the like). In some examples, mobile device 108 may be configured to operate various types of applications associated with media, social networking, phone calls, video conferencing, calendars, games, data communications, and the like. For example, mobile device 108 may be implemented as a media device configured to store, access and play media content.

In some examples, wearable device 112 may be configured to be worn or carried. In some examples, wearable device 112 may be configured to capture sensor data associated with a user's motion or physiology. In some examples, wearable device 112 may be configured to be worn or carried. In some examples, wearable device 112 may be implemented as a data-capable strapband, as described in co-pending U.S. patent application Ser. No. 13/158,372, co-pending U.S. patent application Ser. No. 13/180,320, co-pending U.S. patent application Ser. No. 13/492,857, and co-pending U.S. patent application Ser. No. 13/181,495, all of which are herein incorporated by reference in their entirety for all purposes. In other examples, the quantity, type, function, structure, and configuration of the elements shown may be varied and are not limited to the examples provided.

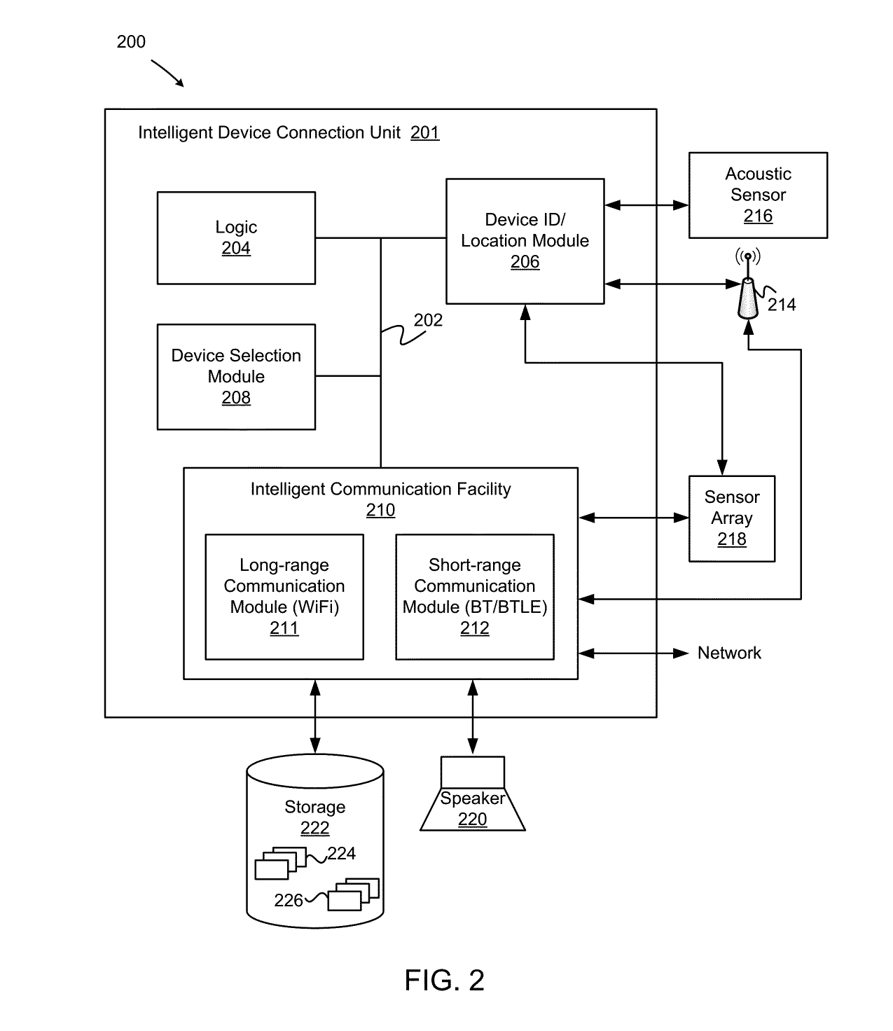

FIG. 2 illustrates a diagram depicting an exemplary architecture for an intelligent device connection unit implemented in a media device. Here, diagram 200 includes intelligent device connection unit 201, antenna 214, acoustic sensor 216, sensor array 218, speaker 220, storage 222, intelligent device connection unit 201 including bus 202, logic 204, device identification/location module 206, device selection module 208, intelligent communication facility 210, long-range communication module 211 and short-range communication module 212. Like-numbered and named elements may describe the same or substantially similar elements as those shown in other descriptions. In some examples, intelligent device connection unit 201 may be implemented in a media device, or other device configured to provide media content (e.g., a mobile device, a headset, a smart speaker, a television, or the like), to identify and locate another device, to receive acoustic output requests from another device (i.e., a request to provide acoustic output) and send back response data associated with said acoustic output, to share data with another device (e.g., setup/configuration data, media content data, user preference data, device profile data, network data, and the like), and to select one or more devices as being suitable and/or optimal for providing media to a user in a context. In some examples, intelligent device connection unit 201 may be configured to generate location data, using device identification/location module 206, the location data associated with a location of another device using radio signal data associated with a radio signal captured by antenna 214, as well as acoustic signal data associated with an acoustic signal captured by acoustic sensor 216. For example, a radio signal from another device may be received by antenna 214, and processed by intelligent communication facility 210 and/or by device identification/location module 206. In some examples, said radio signal may include identifying information, such as an identification of, type of, address for, name for, service offered by/available on, communication capabilities of, acoustic output capabilities of, and other data characterizing, said another device. In some examples, device identification/location module 206 may be configured to evaluate radio signal data to determine a received signal strength of a radio signal, and to compare or correlate a received signal strength with identifying information, for example, to determine whether another device is within a threshold proximity of intelligent device connection unit 201. In some examples, device identification/location module 206 also may be configured to evaluate an acoustic signal to determine a received signal strength of an acoustic signal (i.e., captured using acoustic sensor 216), for example, to generate location data associated with another device, including distance data (i.e., indicating a distance between acoustic sensor 216 and said another device) and directional data (i.e., indicating a direction in which said another device is located relative to acoustic sensor 216), which may be determined, for example, using other location data provided by one or more other media devices in an acoustic network. For example, a stronger received signal strength of an acoustic signal, as evaluated in a context of metadata associated with said acoustic signal, may indicate a source (i.e., said another device) that is closer, and weaker received signal strength of an acoustic signal, again as evaluated in a context of metadata associated with said acoustic signal, may indicate a source that is farther away.

In other examples, location data also may be derived using sensor array 218. In some examples, sensor array 218 may be configured to collect local sensor data, and may include, without limitation, an accelerometer, an altimeter/barometer, a light/infrared (“IR”) sensor, an audio or acoustic sensor (e.g., microphone, transducer, or others), a pedometer, a velocimeter, a global positioning system (GPS) receiver, a location-based service sensor (e.g., sensor for determining location within a cellular or micro-cellular network, which may or may not use GPS or other satellite constellations for fixing a position), a motion detection sensor, an environmental sensor, a chemical sensor, an electrical sensor, or mechanical sensor, and the like, installed, integrated, or otherwise implemented on a media device, mobile device or wearable device, for example, in data communication with intelligent device connection unit 201.

In some examples, intelligent device connection unit 201 may be configured to select a suitable and/or optimal device for providing media content in a context using device selection module 206. In some examples, device selection module 206 may use location data (i.e., based on acoustic signal data generated by acoustic sensor 216, radio signal data generated by antenna 214, and in some examples, additional sensor data captured by sensor array 218 and additional information provided over a network), and cross-reference, correlate, and/or otherwise compare, with sensor data (e.g., derived from acoustic signal data captured by acoustic sensor 216, radio signal data captured by antenna 214, environmental data captured by sensor array 218, and the like), physiological data (i.e., as captured by a wearable device and communicated to intelligent communication facility 210 over a network), identifying information (i.e., provided using a radio signal, for example, by short-range communication or long-range communication, as described herein), and any additionally available context data (e.g., environmental data, social graph data, media services data, other third party data, and the like), to determine whether and which one or more devices in an acoustic network are well-suited, or optimal, for providing a media content. For example, a speaker in an acoustic network closest to a user may be selected by device selection module 206 as well-suited for playing music for a user. In another example, a second-closest speaker may be selected if device selection module 206 determines that another device nearby said closest speaker is playing a different media content for a different user in an adjacent room or environment, such that audio from said music and said different media content does not interfere with each other. In still another example, where a user is consuming video content on a mobile device, and intelligent device connection unit 201 determines said user to have entered a space in which an acoustic network associated with intelligent device connection unit 201 is able to provide video playing services, device selection module 206 may select an available screen (e.g., television, monitor, laptop screen, tablet computer screen, and the like) on a device in said acoustic network to provide said video content. In some examples, device selection module 206 may evaluate context data to determine whether there is other media content being provided by a device in said acoustic network, and to decide automatically based on said context data whether to provide the video on a smaller, more private screen (e.g., mobile device, tablet computer, and the like) using a more private audio output device (e.g., headphones, headset, smaller speakers, and the like), or to provide the video on a larger screen (e.g., television, large monitor, projection screen, and the like) using a more public audio output device (e.g., surround sound speaker system, television speakers, other loudspeakers, and the like). In some examples, intelligent device connection unit 201 may be implemented in a “master” device, configured to make determinations regarding the addition and removal of “slave” devices from an acoustic network, to send control signals and instructions to a “slave” device to provide an acoustic output and acoustic output data to aid in setting up said acoustic network, to send setup and configuration data to a “slave” device joining said acoustic network, and to send control signals to one or more selected “slave” devices in an established acoustic network to provide media content. In some examples, said “master” device may serve as an access point for a “slave” device, for example, a new device joining an acoustic network. In other examples, “master” and “slave” roles may be handed off from one device to another device in an acoustic network, each implementing an intelligent device connection unit. In still other examples, intelligent device connection unit 201 may be implemented in a plurality of devices in an acoustic network, said plurality of devices working together as “peers” to set up ad hoc acoustic networks and provide media content.

In some examples, logic 204 may be implemented as firmware or application software that is installed in a memory. In some examples, logic 204 may include program instructions or code (e.g., source, object, binary executables, or others) that, when initiated, called, or instantiated, perform various functions. In some examples, logic 204 may provide control functions and signals to other components of intelligent device connection unit 201.

In some examples, storage 222 may be configured to store acoustic network data 224 (e.g., identification of, metadata associated with, and other data associated with, one or more devices in an acoustic network) and setup or configuration data 226 (e.g., device profiles, known services, network addresses, hostnames, locations of services, and the like, for various devices or device types/categories). In other examples, storage 222 also may be configured to store location determination data (not shown), including information relating signal strengths (i.e., of radio and acoustic signals) with varying signal properties (e.g., frequencies, waveforms, and the like) and different source types. For example, data may be stored associating a received signal strength of an ultrasonic acoustic signal with an approximate distance of a source, a received signal strength of a radio signal (i.e., Bluetooth®, WiFi, NFC, or the like) in a range of frequencies with a distance of a source, or various received signal strengths of an acoustic signal (i.e., ultrasonic, infrasonic, or human hearing range) with varying distances of a source, and the like (i.e., stored data may describe an association between a signal strength value and a distance value). In another example, data describing threshold proximities for a media device also may be stored. In still other examples, storage 222 also may be configured to store other data (e.g., audio content data, audio library, audio metadata, and the like).

In some examples, intelligent communication facility 210 may include long-range communication module 211 and short-range communication module 212. As used herein, “facility” refers to any, some, or all of the features and structures that are used to implement a given set of functions. In some examples, intelligent communication facility 210 may be configured to communicate wirelessly with another device. For example, short-range communication module 212 may be configured to control data communication using short-range protocols (e.g., Bluetooth®, NFC, ultra wideband, and the like), and in some examples may include a Bluetooth® controller, Bluetooth Low Energy® (BTLE) controller, NFC controller, and the like. In another example, long-range communication module 211 may be configured to control data communication using long-range protocols (e.g., satellite, mobile broadband, global positioning system (GPS), IEEE 802.11a/b/g/n (WiFi), and the like), and in some examples may include a WiFi controller. In other examples, intelligent communication facility may be configured to exchange data with other devices using other protocols (e.g., wireless local area network (WLAN), WiMax, ANT™, ZigBee®, and the like). In some examples, intelligent communication facility may be configured to automatically query and/or send identifying information to another device once antenna 214, sensor array 218, or another sensor, indicates that said another device has crossed or passed within a threshold proximity of intelligent device connection unit 201, or a device or housing within which intelligent device connection unit 201 is implemented. In still other examples, the quantity, type, function, structure, and configuration of the elements shown may be varied and are not limited to the examples provided.

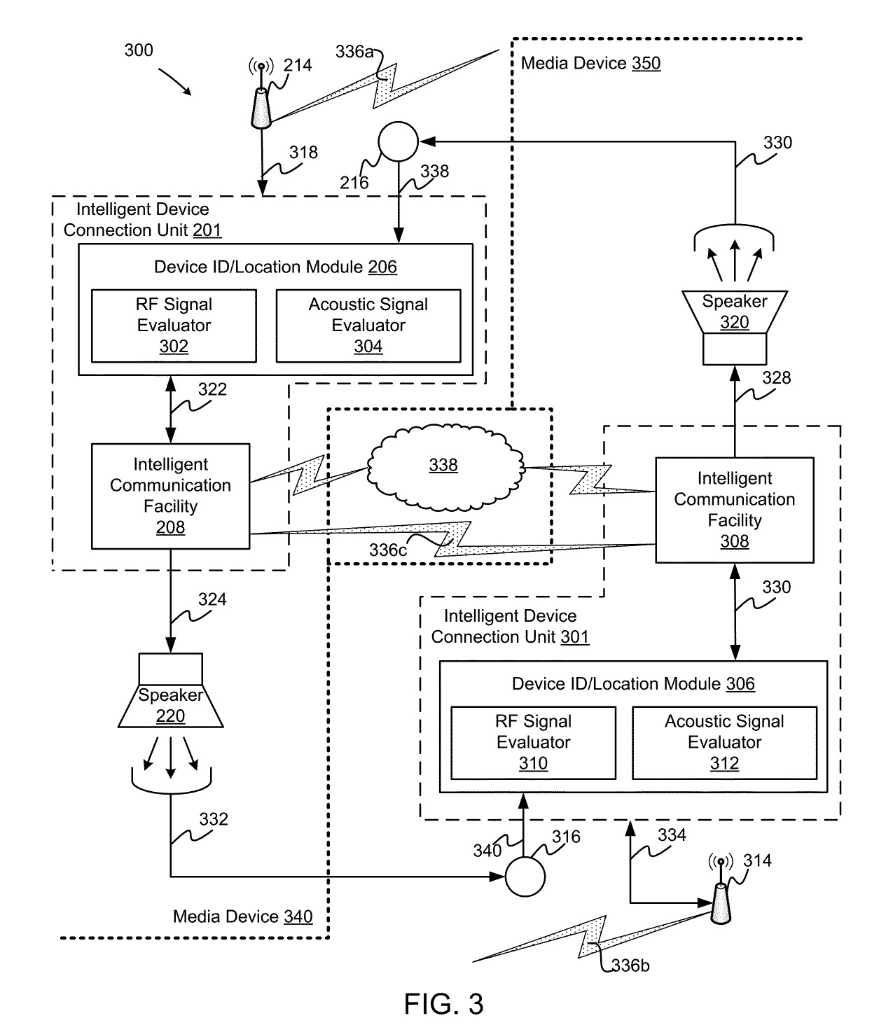

FIG. 3 depicts a functional block diagram depicting interactions between components of wireless media devices implementing intelligent device connection units.

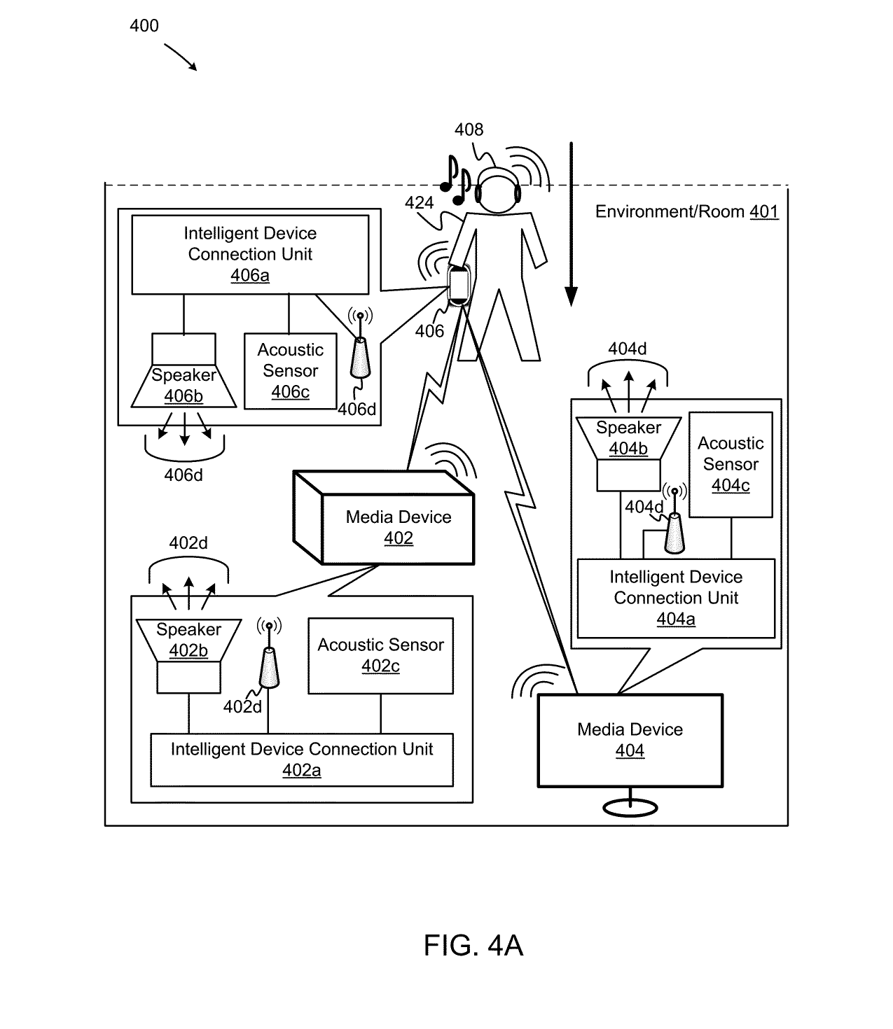

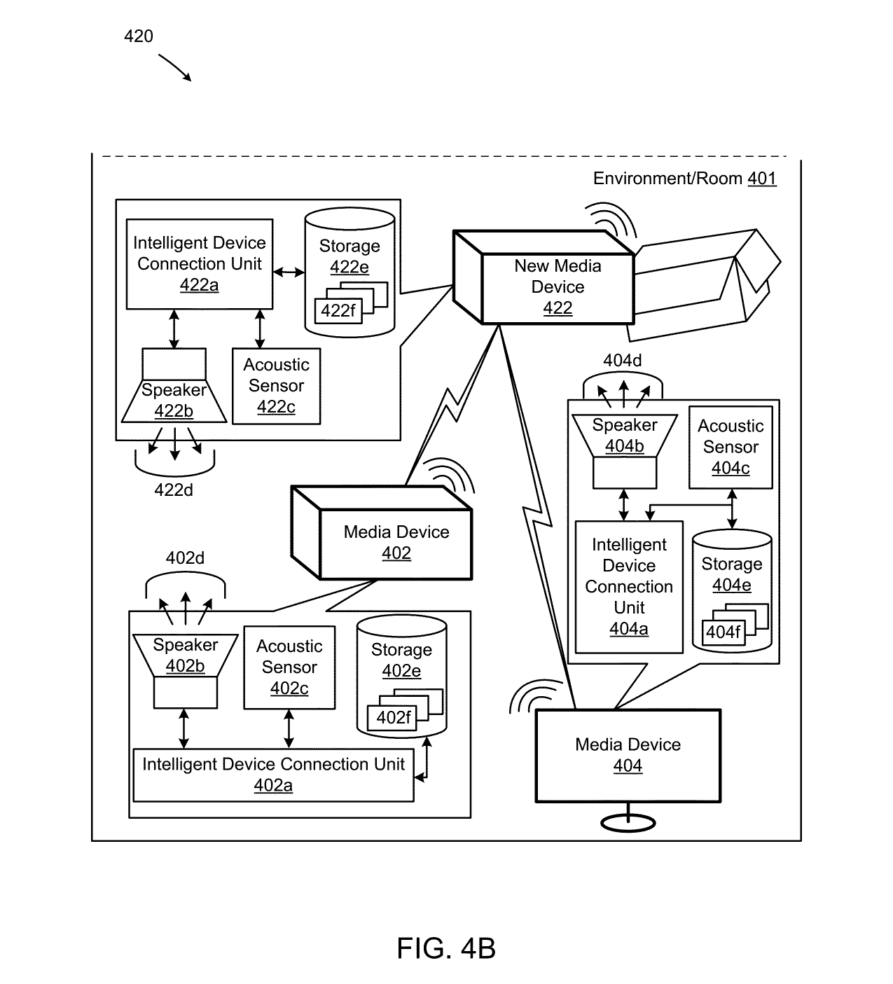

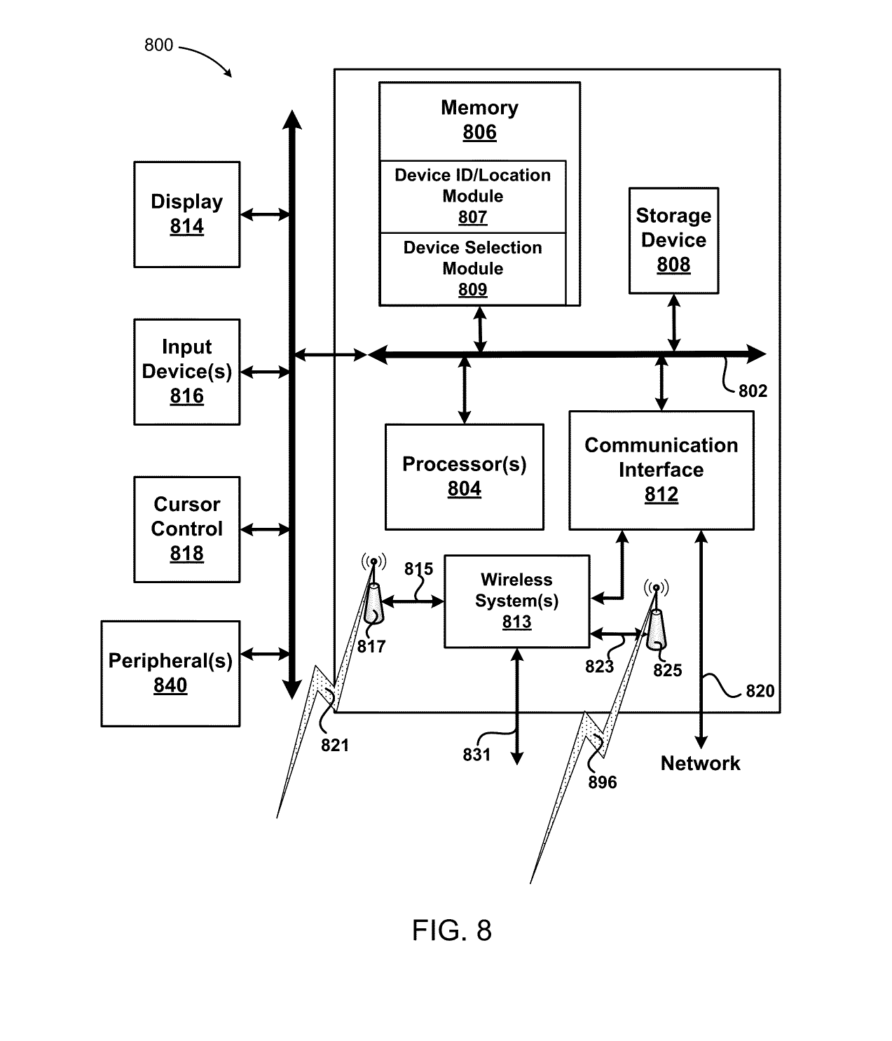

Here, diagram 300 includes intelligent device connection units 201 and 301, antennas 214 and 314, acoustic sensors 216 and 316, speakers 220 and 320, being implemented in media devices 340 and 350, respectively. Intelligent device connection units 201 and 301 include, respectively, intelligent communication facilities 208 and 308, device identification/location modules 206 and 306, which include radio frequency (RF) signal evaluators 302 and 310, and acoustic signal evaluators 304 and 312. Like-numbered and named elements may describe the same or substantially similar elements as those shown in other descriptions. In some examples, intelligent device connection unit 201 may receive radio signal data 318 from antenna 214, which may be associated with radio signal 336a captured by antenna 214. In some examples, radio signal 336a may be associated with an RF signal output by media device 350 (i.e., using antenna 314). In other examples, radio signal 336a may be from a different source. In some examples, RF signal evaluator 302 may evaluate radio signal data 318 to parse any identifying information and to determine a received signal strength. In an example, if no identifying information is included in radio signal data 318, then RF signal evaluator 302 may be configured to instruct intelligent communication facility to send a query to media device 350 (i.e., in data communication using intelligent communication facility 308), either directly through signal 336c (i.e., a radio signal using a short-range communication protocol) or indirectly through network 338 (i.e., a radio signal using a long-range communication protocol), requesting identifying information. In some examples, media device 350 may be configured to send identifying information in response to said request back, for example, using antenna 314 and a short-range or long-range communication protocol, as described herein. In another example, if identifying information is included in radio signal data 318, RF signal evaluator 302 may be configured to generate preliminary location data to determine whether media device 350 is located within a threshold proximity of media device 340. In some examples, RF signal evaluator 302 may instruct intelligent communication facility 208 to send a query to media device 350, upon determining media device 350 to be located within a threshold proximity of media device 340, requesting media device 350 to provide an acoustic output (e.g., a tone, a music sample, an ultrasonic acoustic signal in a suggested frequency range and of a suggested length, an infrasonic acoustic signal in a suggested frequency range and of a suggested length, and the like), and to provide response data confirming the transmission of said acoustic output. Intelligent device connection unit 301 may be configured to send an instruction by signal 330 to intelligent communication facility 308 to send a control signal 328 to speaker 320 to provide said acoustic output, and also to send response data back (i.e., by radio signal 336c or through network 338) to intelligent device connection unit 201, said response data identifying and characterizing said acoustic output (i.e., confirming when it was provided, with what type of acoustic signal, duration, magnitude, and the like). Said acoustic output by speaker 320 may then be captured by acoustic sensor 216 as acoustic signal 330, which may result in acoustic signal data 338 being sent to device identification/location module 206 to be evaluated using acoustic signal evaluator 304. In some examples, acoustic signal evaluator 304 may be configured to evaluate acoustic signal data 338 to determine a received signal strength, and to correlate and compare a received signal strength with associated response data, for example, to determine a delay between a time acoustic signal 330 is output by speaker 320 and another time when acoustic signal 330 is received by acoustic sensor 216. Acoustic signal evaluator 304 also may be configured to generate and/or update location data associated with media device 350 using an evaluation of acoustic signal data 338, including a distance between media devices 340 and 350, and a direction, for example, relative to a central axis of media device 340 or another reference point. In some examples, acoustic evaluator 304 may determine, based on said location data, that media device 350 is suitable to be included in an acoustic network with media device 340. In some examples, intelligent device connection unit 201 may be configured to store said location data, along with acoustic network data, associated with media device 350 in a storage device (e.g., storage 222 in FIG. 2, storages 402e, 404e and 422e in FIG. 4B, storage device 808 in FIG. 8, and the like). In other examples, the quantity, type, function, structure, and configuration of the elements shown may be varied and are not limited to the examples provided.

In some examples, media device 350 may be configured to also query media device 340, in a similar manner as described above, to provide a similar or different acoustic output so that media device 350 may make its own determination as to a location and identity of media device 340. For example, intelligent communication facility 208 may instruct speaker 220, using control signal 324, to provide an acoustic output according to a set of parameters, in response to which speaker 220 may output acoustic signal 332, which may be captured by acoustic sensor 316. In this example, acoustic sensor 316 may, in response to sensing acoustic signal 332, send acoustic signal data 340 to device identification/location module 306 to be evaluated using acoustic signal evaluator 312. In this example, acoustic evaluator 312 then may generate and/or update location data by evaluating acoustic signal data 340, and determine based on said location data that media device 340 is suitable to be included in an acoustic network with media device 350. In some examples, intelligent device connection unit 301 may be configured to store said location data, along with acoustic network data, associated with media device 350 in a storage device (e.g., storage 222 in FIG. 2, storages 402e, 404e and 422e in FIG. 4B, storage device 808 in FIG. 8, and the like). In other examples, the quantity, type, function, structure, and configuration of the elements shown may be varied and are not limited to the examples provided.

FIGS. 4A-4B depicts ad hoc expansion of an acoustic network. Here, diagram 400 includes environment/room 401, media devices 402-404, mobile device 406 and headphones 408. Media device 402 may include intelligent device connection unit 402a, speaker 402b, acoustic sensor 402c and antenna 402d. Media device 404 may include intelligent device connection unit 404a, speaker 404b, acoustic sensor 404c and antenna 404d. Mobile device 406 may include intelligent device connection unit 406a, speaker 406b, acoustic sensor 406c and antenna 406d. Like-numbered and named elements may describe the same or substantially similar elements as those shown in other descriptions. In some examples, media devices 402-404, mobile device 406 and headphones 408 may be configured to communicate, and exchange data, with each other wirelessly (i.e., using radio signals). In some examples, media device 402-404 may be part of an acoustic network established in environment/room 401, for example, with a threshold proximity reaching each wall of environment/room 401. In some examples, user 424 may enter environment/room 401 playing music stored or streamed from mobile device 406 and output using headphones 408. In some examples, mobile device 406 may be configured to sense a radio signal emitted by one or both of media devices 402-404 upon entry (i.e., using antenna 406d), and media devices 402-404 also may be configured to sense, for example, a radio signal being emitted by mobile device 406 to play music using headphones 408 (i.e., using antennas 402d and 404d). In some examples, from such a radio signal, one or both of media devices 402-404 may be configured to determine preliminary location data, and to obtain identifying information, associated with mobile device 406. In other examples, such a radio signal may only provide enough data for a preliminary location determination (i.e., indicating that mobile device 406 has breached or crossed into a threshold proximity of media device 402 and/or media device 404), and one or both of media devices 402-404 may be configured to query mobile device 406 (i.e., using intelligent device connection units 402a and 404a) to request an acoustic output and response data relating to said acoustic output.

In some examples, one or more of media devices 402-404 and mobile device 406 may determine ad hoc, using processes described herein, that mobile device 406 is suitable for inclusion in an acoustic network previously established between media device 402 and media device 404. In some examples, upon said ad hoc determination, acoustic network data may be exchanged between media devices 402-404 and mobile device 406 to add or include mobile device 406 to said acoustic network, so that one or both of media devices 402-404 may be considered and selected for providing music to user 424. In other examples, the quantity, type, function, structure, and configuration of the elements shown may be varied and are not limited to the examples provided.

In FIG. 4B, diagram 420 includes media devices 402-404, as described above, as well as new media device 422, which includes intelligent device connection unit 422a, speaker 422b, acoustic sensor 422c and storage 422e. In some examples, media devices 402-404 and new media device 422 may be located in environment/room 401. Like-numbered and named elements may describe the same or substantially similar elements as those shown in other descriptions. In some examples, new media device 422 may be configured to detect automatically when it is taken out of a shipping package and to enter a power mode (e.g., setup mode, startup mode, configuration mode, or the like) enabling use of speaker 422b and acoustic sensor 422c, techniques for which are described in co-pending U.S. patent application Ser. No. 13/405,240, filed Feb. 25, 2012, with Attorney Docket No. ALI-002CON1, which is herein incorporated by reference in its entirety for all purposes. In some examples, new media device 422 may be configured to query media devices within a threshold proximity (e.g., media devices 402-404) automatically, upon entering a setup/startup/configuration mode, to set up an acoustic network and exchange setup and/or configuration data (i.e., to store as setup/configuration data 4220.

In other examples, media devices 402-404 may be configured to add new media device 422 to an existing acoustic network, or to establish a new acoustic network between media devices 402-404 and new media device 422, and to provide new media device 422 with setup and/or configuration data (i.e., setup/configuration data 402f, setup/configuration data 404f, and the like), such that new media device 422 may store said setup and/or configuration data in storage 422e, for example, as setup/configuration data 422f. In some examples, new media device 422 also may use one or both of media devices 402-404 to be an access point for further data gathering. In other examples, the quantity, type, function, structure, and configuration of the elements shown may be varied and are not limited to the examples provided.

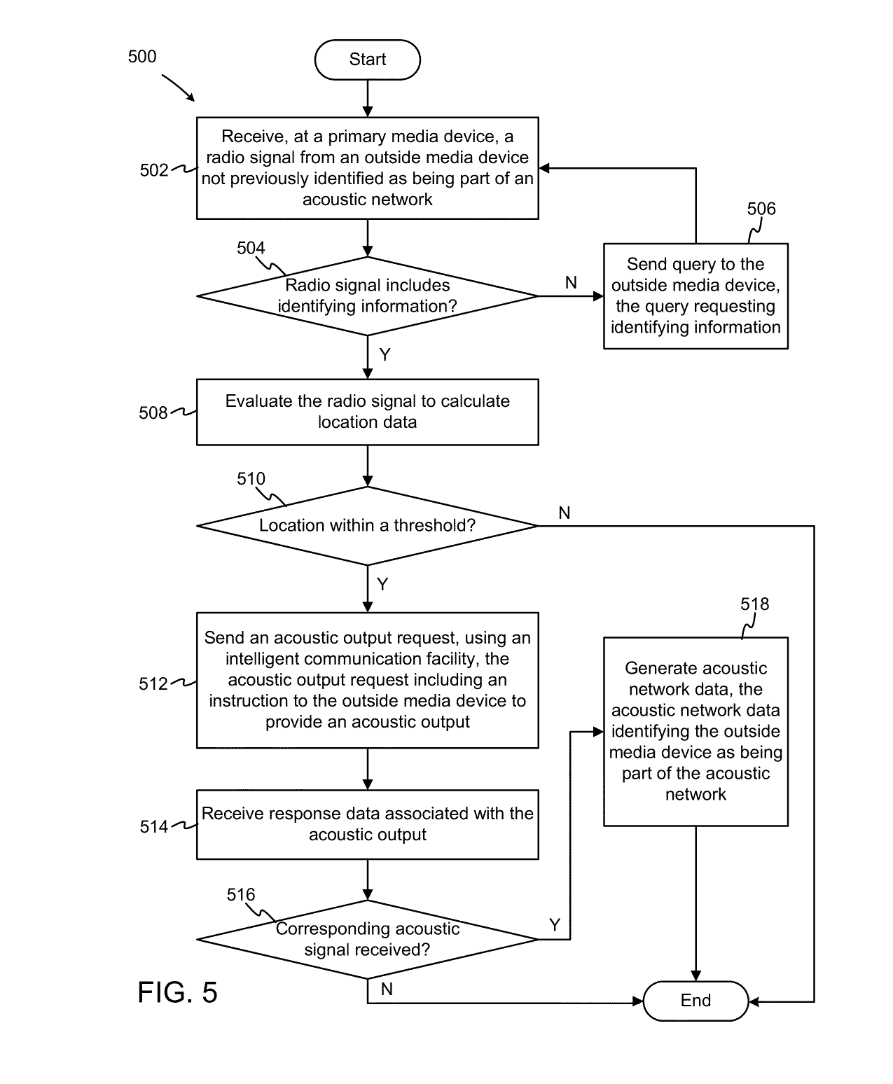

FIG. 5 illustrates an exemplary flow for ad hoc expansion of an acoustic network. Here, flow 500 begins with receiving, at a primary media device, a radio signal from an outside media device not previously identified as being part of an acoustic network (502). In some examples, a received radio signal may provide an automatic indication whether its source (i.e., the outside media device) is a part of the acoustic network with the primary media device. In other examples, identifying information may be obtained. A determination may be made whether said radio signal includes identifying information (504), for example, using a RF signal evaluator implemented in a device identification/location module as part of an intelligent device connection unit, as described herein. If no, or if there is insufficient identifying information, then a query is sent to the outside media device requesting identifying information (506), and then another radio signal may be sent by the outside media device and received by the primary media device. In some examples, identifying information may include metadata associated with a communication protocol (i.e., short-range or long-range radio frequency protocols) associated with said radio signal. Such identifying information may provide primary media device with context for evaluating said radio signal. If said radio signal includes sufficient identifying information, the primary media device may proceed to evaluate the radio signal to calculate location data (508), for example, using a received signal strength and identifying information about a source of the radio signal. In some examples, said location data may be sufficient to identify a location of the outside media device, for example, relative to the primary media device, or another predetermined reference point. In some examples, said location may indicate a distance from the primary media device (i.e., location data includes distance data based on a received signal strength of the radio signal). In some examples, said location also may indicate a direction (i.e., determined using two or more devices in an acoustic network, each calculating a distance from the outside media device, comparing with a known (i.e., previously established) distance between the two or more devices, and sharing this distance data to determine directionality of devices). A determination may be made by the primary media device whether said location is within a threshold proximity (510). If no, then the outside media device is not suitable to be included in an acoustic network with the primary media device, and the process ends. If yes, then the primary media device may proceed with sending an acoustic output request to the outside media device, using an intelligent communication facility, the acoustic output request including an instruction to the outside media device to provide an acoustic output (512). In some examples, said request also may include an instruction to provide response data confirming transmission of said acoustic output, including metadata about said transmission, including one or more of a time or time period associated with the acoustic output (i.e., indicating when the acoustic output was, is being, or will be, transmitted), a length of the acoustic output, a type of the acoustic output (i.e., ultrasonic, human hearing range, infrasonic, and the like). Said response data may be received by the primary media device (514), for example, using another radio signal transmission (i.e., by short-range or long-range communication protocols, as described herein). A determination may then be made whether a corresponding acoustic signal is received (516), for example, captured by an acoustic sensor implemented in the primary media device. If no acoustic signal is received that corresponds to the acoustic output described in the response data, either because there is an obstruction between the primary media device, too much distance, or for another reason, then the outside media device is not suitable to be included in an acoustic network with the primary media device, and the process ends. In some examples, a corresponding acoustic signal exceeds a minimum threshold received signal strength, and is captured within a maximum delay threshold. Any acoustic signal, even one matching other characteristics of the outside media device's acoustic output, that falls below a minimum threshold received signal strength and/or is received outside of a maximum delay threshold (i.e., time period following a time of transmission of said acoustic output), may not qualify as a corresponding acoustic signal. If yes, a corresponding acoustic signal is received, then acoustic network data is generated by the primary media device, or in some examples, by another media device previously established as part of an acoustic network with the primary media device, the acoustic network data identifying the outside media device as being part of the acoustic network (518). In some examples, acoustic network data includes updated location data, based on characteristics of a received acoustic signal (e.g., received signal strength of an acoustic signal, type of acoustic signal, magnitude of acoustic signal at source, and the like). In other examples, the above-described process may be varied in steps, order, function, processes, or other aspects, and is not limited to those shown and described.

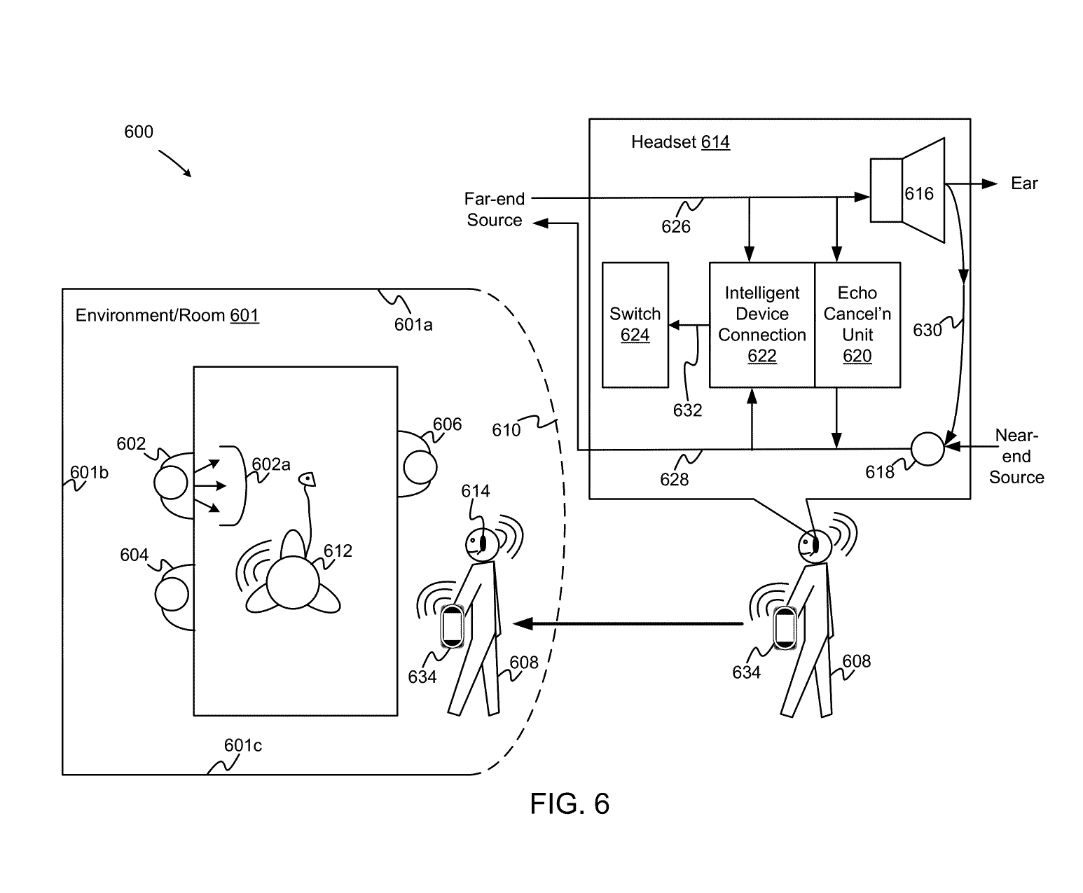

FIG. 6 depicts an exemplary flow of signals in a headset implementing an intelligent device connection unit. Here, diagram 600 includes environment/room 601, defined on three sides by walls 601a-601c, users 602-608, threshold 610, speakerphone 612, headset 614, speaker 616, acoustic sensor 618, echo cancelation unit 620, intelligent device connection unit 622, switch 624, incoming audio signal 626, outgoing audio signal 628, echo signal 630, control signal 632, and mobile device 634. Like-numbered and named elements may describe the same or substantially similar elements as those shown in other descriptions. In some examples, speakerphone 612, headset 614 and mobile device 634, may be wireless devices configured to communicate with each other using one or more of wireless communication protocols, as described herein. In some examples, environment/room 601 may be a far-end source of audio content (e.g., speech 602a from user 602, and the like), as captured by speakerphone 612, being communicated to headset 614, either directly or indirectly through mobile device 634. In some examples, audio content from far-end source may be provided through incoming audio signal 626 to speaker 616 for output to an ear. In some examples, incoming audio signal 626 also may be provided to echo cancelation unit 620, which may be configured to subtract or remove incoming audio signal 626, or its equivalent signal, from outgoing audio signal 628, which may include an echo signal 630 of incoming audio signal 626 output by speaker 616 and picked up by acoustic sensor 618. In some examples, incoming audio signal 626 also may be provided to intelligent device connection unit 622 to compare with outgoing audio signal 628, in some examples, after echo signal 630 is removed, to determine whether a near-end source (e.g., user 608's voice, skin surface and/or ambient noise from user 608's environment) is converging with a far-end source. For example, as user 608 draws near, or crosses, a threshold 610, wherein audio or other acoustics from environment/room 601 may be heard or picked up by acoustic sensor 618, acoustic sensor 618 may pick up far-end source acoustics or audio as part of ambient noise from user 608's environment. In this example, intelligent device connection unit 622 may be configured to recognize such ambient noise as being similar (i.e., having some of the same characteristics and waveforms) or identical to incoming audio signal 626, but maybe in a shifted, delayed, muted or otherwise altered, manner. Intelligent device connection unit 622 may determine, based on an identification of such similar or identical component in outgoing audio signal 628, that user 608 is drawing near or entering the same environment as a far-end source (i.e., that a near-end source and a far-end source are converging). As user 608 draws nearer, or farther into, environment/room 601, the delay between incoming audio signal 626 and its corresponding component in outgoing audio signal 628 may become shorter, and a difference in magnitudes may become smaller, until a threshold is reached indicating that user 608 is within a sufficient human hearing distance of far-end source (i.e., environment/room 601) to participate in a conversation with users 602-606 without headset 614. In some examples, once that threshold is reached, intelligent device connection unit 622 may be configured to send control signal 632 to switch 624 to turn off headset 614. In other examples, control signal 632 may be configured to mute at least speaker 616 (and in some examples, acoustic sensor 618 as well), such that user 608 may continue a conversation with users 602-606 seamlessly upon entering environment/room 601 without any manual manipulation of headset 614.

In some examples, where speaker 616 is muted, but headset 614 remains in a muted, sensory mode, intelligent device connection may be configured to determine when user 608 leaves environment/room 601, and to send a control signal 632 to switch 624 to unmute speaker 616, and in some examples, to turn on other functions of headset 614, upon reaching a threshold indicating when user 608 is out of hearing distance of a far-end source environment/room 601, such that user 608 may seamlessly continue a conversation with users 602-606 using headset 614, as user 608 leaves environment/room 601 without any manual manipulation of headset 614. In other examples, the quantity, type, function, structure, and configuration of the elements shown may be varied and are not limited to the examples provided.

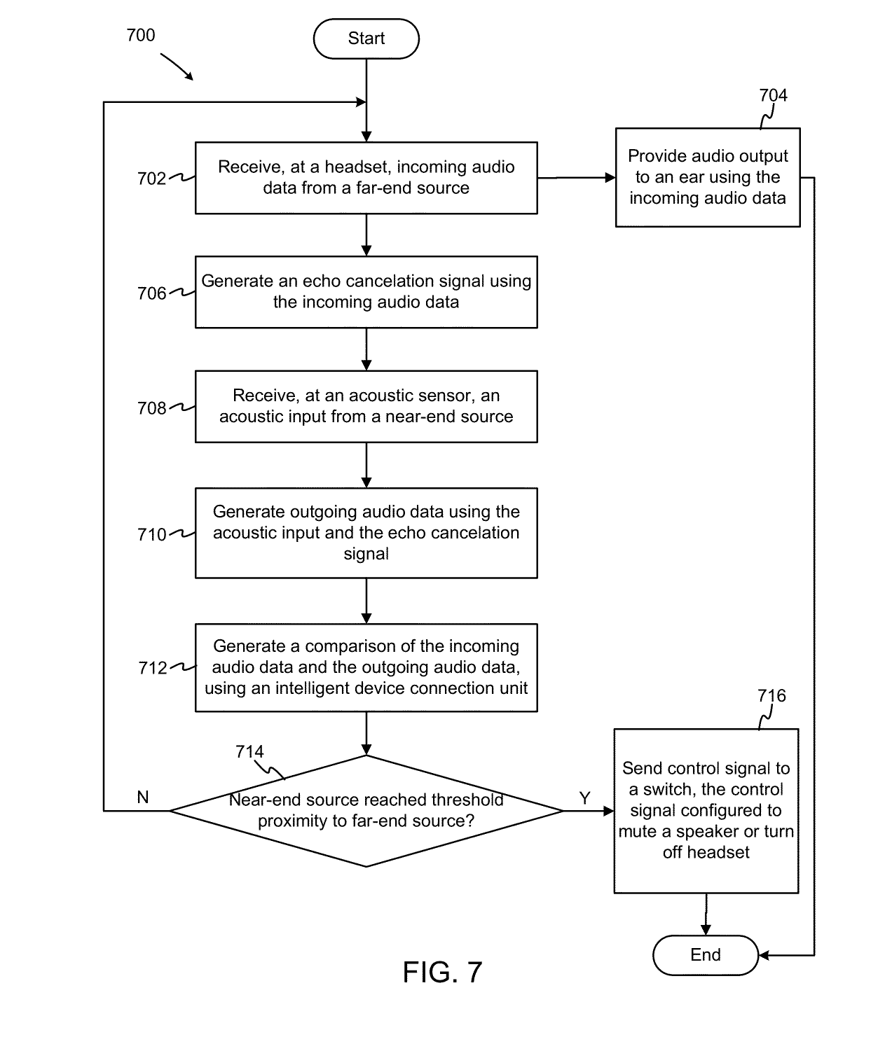

FIG. 7 illustrates an exemplary flow for ad hoc switching of a headset implementing an intelligent device connection unit. Here, process 700 begins with receiving, at a headset, incoming audio data from a far-end source (702). In some examples, an audio output may be provided to an ear using the incoming audio data (704), the audio output being provided using a speaker implemented in said headset. An echo cancelation signal may be generated using the incoming audio data (706), for example, using an echo cancelation unit, said echo cancelation signal corresponding to an incoming audio signal. An acoustic input may be received, at an acoustic sensor, from a near-end source (708). In some examples, a near-end source may comprise a voice, a skin surface, or other source from which an acoustic sensor may capture an acoustic signal. Outgoing audio data may be generated using the acoustic input and the echo cancelation signal (710). In some examples, an acoustic sensor may pick up both speech and an echo from the headset speaker's output (i.e., corresponding to said incoming audio data), including both in an outgoing audio signal, and thus said echo cancelation signal may be subtracted or removed from an outgoing audio signal. Then a comparison of the incoming audio data and the outgoing audio data may be generated using an intelligent device connection unit (712), as described herein. For example, incoming audio data and outgoing audio data, as modified by an echo cancelation unit, may be evaluated to determine whether a headset acoustic sensor is picking up ambient noise (i.e., acoustic input) similar, or identical, to said incoming audio data, in a phase-shifted, delayed, muted, or otherwise altered, manner. As the delay diminishes, and other characteristics of the near-end acoustics grow more and more similar to incoming audio from a far-end source, a determination may be made whether a near-end source has reached a threshold proximity to a far-end source (714), such that a user of a headset is within hearing distance of said far-end source. If no, then process 700 begins again to monitor any convergence of a near-end source with a far-end source. If yes, then a control signal is sent to a switch, the control signal configured to mute a speaker or to turn off the headset (716), so that a user may continue a conversation with a far-end source upon entering said far-end source environment without manually switching or otherwise manipulating the headset. In some examples, the headset remains powered (i.e., on) so that an acoustic sensor on the headset may continue to capture acoustic input, and an intelligent device connection unit may determine if and when a user exits a far-end environment, and automatically unmute a speaker to allow said conversation to continue seamlessly. In other examples, the above-described process may be varied in steps, order, function, processes, or other aspects, and is not limited to those shown and described.

FIG. 8 illustrates an exemplary computing platform disposed in a media device implementing an intelligent device connection unit. Like-numbered and named elements may describe the same or substantially similar elements as those shown in other descriptions. In some examples, computer system 800 may be used to implement circuitry, computer programs, applications (e.g., APP's), configurations (e.g., CFG's), methods, processes, or other hardware and/or software to implement techniques described herein. Computer system 800 includes a bus 802 or other communication mechanism for communicating information, which interconnects subsystems and devices, such as one or more processors 804, system memory 806 (e.g., RAM, SRAM, DRAM, Flash), storage device 808 (e.g., Flash Memory, ROM, disk drive), communication interface 812 (e.g., modem, Ethernet, one or more varieties of IEEE 802.11, WiFi, WiMAX, WiFi Direct, Bluetooth, Bluetooth Low Energy, NFC, Ad Hoc WiFi, HackRF, USB-powered software-defined radio (SDR), WAN or other), display 814 (e.g., CRT, LCD, OLED, touch screen), one or more input devices 816 (e.g., keyboard, stylus, touch screen display), cursor control 818 (e.g., mouse, trackball, stylus), one or more peripherals 840. Some of the elements depicted in computer system 800 may be optional, such as elements 814-818 and 840, for example and computer system 800 need not include all of the elements depicted.

According to some examples, computer system 800 performs specific operations by processor 804 executing one or more sequences of one or more instructions stored in system memory 806. Such instructions may be read into system memory 806 from another non-transitory computer readable medium, such as storage device 808. In some examples, system memory 806 may include device identification/location module 807 configured to provide instructions for evaluating RF and acoustic signals to generate location data associated with a source device, as described herein. In some examples, system memory 806 also may include device selection module 509 configured to provide instructions for selecting a device in an acoustic network for providing a media content, as described herein. In some examples, circuitry may be used in place of or in combination with software instructions for implementation. The term “non-transitory computer readable medium” refers to any tangible medium that participates in providing instructions to processor 804 for execution. Such a medium may take many forms, including but not limited to, non-volatile media and volatile media. Non-volatile media includes, for example, Flash Memory, optical, magnetic, or solid state disks, such as disk drive 810. Volatile media includes dynamic memory (e.g., DRAM), such as system memory 806. Common forms of non-transitory computer readable media includes, for example, floppy disk, flexible disk, hard disk, Flash Memory, SSD, magnetic tape, any other magnetic medium, CD-ROM, DVD-ROM, Blu-Ray ROM, USB thumb drive, SD Card, any other optical medium, punch cards, paper tape, any other physical medium with patterns of holes, RAM, PROM, EPROM, FLASH-EPROM, any other memory chip or cartridge, or any other medium from which a computer may read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 802 for transmitting a computer data signal. In some examples, execution of the sequences of instructions may be performed by a single computer system 800. According to some examples, two or more computer systems 800 coupled by communication link 820 (e.g., LAN, Ethernet, PSTN, wireless network, WiFi, WiMAX, Bluetooth (BT), NFC, Ad Hoc WiFi, HackRF, USB-powered software-defined radio (SDR), or other) may perform the sequence of instructions in coordination with one another. Computer system 800 may transmit and receive messages, data, and instructions, including programs, (e.g., application code), through communication link 820 and communication interface 812. Received program code may be executed by processor 804 as it is received, and/or stored in a drive unit 810 (e.g., a SSD or HD) or other non-volatile storage for later execution. Computer system 800 may optionally include one or more wireless systems 813 in communication with the communication interface 812 and coupled (signals 815 and 823) with antennas 817 and 825 for receiving and/or transmitting RF signals 821 and 896, such as from a WiFi network, Bluetooth® radio, or other wireless network and/or wireless devices, devices 102-112, 122, 340, 350, 402-406, 422, 612-614 and 634, for example. Examples of wireless devices include but are not limited to: a data capable strap band, wristband, wristwatch, digital watch, or wireless activity monitoring and reporting device; a smartphone; cellular phone; tablet; tablet computer; pad device (e.g., an iPad); touch screen device; touch screen computer; laptop computer; personal computer; server; personal digital assistant (PDA); portable gaming device; a mobile electronic device; and a wireless media device just to name a few. Computer system 800 in part or whole may be used to implement one or more systems, devices, or methods that communicate with devices 102-112, 122, 340, 350, 402-406, 612-614 and 634 via RF signals (e.g., 896) or a hard wired connection (e.g., data port). For example, a radio (e.g., a RF receiver) in wireless system(s) 813 may receive transmitted RF signals (e.g., 896 or other RF signals) from devices 102-112, 122, 340, 350, 402-406, 612-614 and 634 that include one or more datum (e.g., sensor system information, content, data, or other). Computer system 800 in part or whole may be used to implement a remote server or other compute engine in communication with systems, devices, or method for use with the devices 100-112, 122, 340, 350, 402-406, 612-614 and 634, or other devices as described herein. Computer system 800 in part or whole may be included in a portable device such as a wearable display, smartphone, media device, wireless client device, tablet, or pad, for example.

As hardware and/or firmware, the structures and techniques described herein can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, intelligent communication module 812, including one or more components, can be implemented in one or more computing devices that include one or more circuits. Thus, at least one of the elements in FIGS. 1-4B & 6 can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed is:

1. A method, comprising:
receiving, at a primary media device, a radio signal from an outside media device not part of an acoustic network to which the primary media device belongs;
determining whether the radio signal includes identifying information;
evaluating, using the identifying information, the radio signal to calculate location data associated with a location of the outside media device;
determining whether the location of the outside media device is within a threshold proximity of the primary media device;
sending an acoustic output request to the outside media device, using a radio frequency signal, when the outside media device is within the threshold proximity of the primary media device, the acoustic output request comprising an instruction to the outside media device to provide an acoustic output;
receiving response data from the outside media device, the response data associated with the acoustic output;
capturing an acoustic signal using an acoustic sensor implemented in the primary media device;
determining, using the response data, the acoustic signal to be associated with the acoustic output from the outside media device; and
generating acoustic network data using the acoustic signal, the acoustic network data identifying the outside media device as being part of the acoustic network.

2. The method of claim 1, wherein the generating the acoustic network data comprises updating the location data associated with the outside media device using the acoustic signal and the response data.

3. The method of claim 1, wherein the location data comprises distance data based on one or more of a first received signal strength of the radio signal and a second received signal strength of the acoustic signal.

4. The method of claim 1, wherein the location data comprises distance data based on a received signal strength of the radio signal and the identifying information.

5. The method of claim 1, wherein the identifying information comprises metadata associated with a communication protocol associated with the radio signal.

6. The method of claim 1, wherein the location data comprises directional data.

7. The method of claim 1, further comprising sending a query to the outside media device, when the radio signal does not include identifying information associated with the outside media device, the query requesting the identifying information.

8. The method of claim 1, wherein the determining whether the location of the outside media device is within the threshold proximity of the primary media device comprises comparing the threshold proximity with distance data indicating a distance between the primary media device and the outside media device.

9. The method of claim 1, wherein the threshold proximity indicates a maximum distance away from the primary media device within which a secondary device may be included in an acoustic network with the primary media device.

10. The method of claim 1, wherein the acoustic signal comprises an ultrasonic sound wave.

11. The method of claim 1, wherein the acoustic signal comprises an infrasonic sound wave.

12. The method of claim 1, wherein the acoustic signal comprises a sound wave within a human hearing range.

13. The method of claim 1, wherein the response data includes metadata associated with the acoustic output, the metadata indicating a time associated with the acoustic output.

14. The method of claim 13, wherein the time comprises a time period during which the acoustic output is being provided by the outside media device.

15. The method of claim 1, wherein the response data includes metadata associated with the acoustic output, the metadata indicating a length of the acoustic output and a time associated with the acoustic output.

16. The method of claim 1, wherein the response data includes metadata associated with the acoustic output, the metadata indicating a type of the acoustic output.

17. A method, comprising:
receiving, at a primary media device, a first radio signal from a first outside media device and a second radio signal from a second outside media device, the first outside media device and the second outside media device not part of an acoustic network to which the primary media device belongs;
determining the first radio signal to include a first indentifying information associated with the first outside media device and the second radio signal to include a second identifying information associated with the second outside media device;
calculating, using the first identifying information, a first location data associated with a first location of the first outside media device;
calculating, using the second identifying information, a second location data associated with a second location of the second outside media device;
determining one or both of the first location and the second location to be within the threshold proximity;
sending an acoustic output request comprising an instruction to provide an acoustic output, the acoustic output request being sent to one or both of the first outside media device and the second outside media device;
receiving response data from the one or both of the first outside media device and the second outside media device, the response data associated with the acoustic output;
capturing an acoustic signal using an acoustic sensor implemented in the primary media device;
recognizing the acoustic signal as being associated with the acoustic output; and
generating acoustic network data identifying at least one of the one or both of the first outside media device and the second outside media device as being in the acoustic network.

18. The method of claim 17, further comprising identifying a source of the acoustic signal, the source comprising the one or both of the first outside media device and the second outside media device.

19. The method of claim 17, wherein the response data comprises metadata indicating a time and a type associated with the acoustic output.

20. The method of claim 17, wherein the generating the acoustic network data comprises updating one or both of the first location data and the second location data using the acoustic signal and the response data.
